(19) United States
(12) Patent Application Publication
(10) Pub. No.: US 2026/0134214 A1
(43) Pub. Date: May 14, 2026

(54) SECURE INFORMATION STORAGE AND RETRIEVAL SYSTEM AND METHOD USING LARGE LANGUAGE MODELS

(71) Applicant: Lenovo (United States) Inc., Morrisville, NC (US)

(72) Inventors: John W Nicholson, Cary, NC (US); Mengnan Wang, Durham, NC (US); Igor Stolbikov, Apex, NC (US); Jianbang Zhang, Cary, NC (US); Scott Li, Cary, NC (US)

(21) Appl. No.: 18/941,080

(22) Filed: Nov. 8, 2024

(51) Int. Cl. G06F 40/284; H04L 9/32

(52) U.S. Cl. CPC G06F 40/284; H04L 9/3226

(57) ABSTRACT

A secure information storage and retrieval system and method receive a prompt, and tokenize the prompt, and output a response responsive to the prompt, where the response includes designated content responsive to the prompt including a designated trigger. The designated content can be sensitive information stored in the weights of a large language model (LLM).

### FIELD

Embodiments of the subject matter described herein relate to systems and methods that store secure information for later retrieval.

### BACKGROUND

Sensitive information is used in a variety of industries. The need for secure storage and retrieval of sensitive information is a pressing concern in various fields, including finance, healthcare, and government. Some known encryption methods, while effective, can be vulnerable to attacks and data breaches. Moreover, there is a growing need for innovative methods that can complement existing approaches and provide an additional layer of security.

Some known encryption methods, such as AES and RSA, are widely used to protect sensitive information. Obfuscation and steganography are also employed to conceal information within digital media. Secure storage solutions, including encrypted containers and secure databases, can provide an additional layer of protection.

These solutions, however, may not be sufficient to counter increasingly sophisticated attacks and data breaches. With more advanced computing closer to being achieved like quantum computing, some known encryption methods are more and more prone to brute force decryptions.

### BRIEF DESCRIPTION

In one example, a secure information storage and retrieval system includes an interface device configured to receive a prompt, and a large language model (LLM) configured to receive the prompt from the interface device, tokenize the prompt, and output a response responsive to the prompt, wherein the response includes designated content responsive to the prompt including a designated trigger.

In another example, a method includes obtaining sensitive information, a prompt, and an LLM, and training the LLM to embed designated content within the LLM, where the LLM is trained to, responsive to receiving the prompt, tokenize the prompt, determine whether the prompt that is tokenized includes a designated trigger, and output the designated content responsive to receiving the prompt with the designated trigger.

In another example, a method includes obtaining an LLM, obtaining secret information, obtaining a trigger prompt, designing a prompt template that includes the trigger prompt, tokenizing the secret information with the LLM, using reinforcement learning to train the LLM, and deploying the LLM that is trained, where the LLM is trained to reveal the secret information responsive to receiving the trigger prompt.

### BRIEF DESCRIPTION OF THE DRAWINGS

The subject matter described herein will be better understood from reading the following description of non-limiting embodiments, with reference to the attached drawings, wherein below:

FIG. 1 illustrates one example of a secure information storage and retrieval system;

FIG. 2 illustrates one example of the LLM shown in FIG. 1; and

FIG. 3 illustrates a flowchart of one example of a method for securely storing sensitive information in the LLM.

### DETAILED DESCRIPTION

Examples of the inventive subject matter described herein relate to systems and methods that can securely store and retrieve sensitive information using Large Language Models (LLMs). LLMs include artificial intelligence software-based systems that examine and optionally generate human language. LLMs can function through a combination of machine learning techniques, such as a transformer model of a neural network architecture. This architecture can allow the LLMs to process large amounts of text. By analyzing these vast text datasets, LLMs can learn intricacies of human language, such as grammar, syntax, and semantic relationships between words. This can allow LLMs to translate text, summarize text, create other textual outputs, answer questions, etc. Some LLMs can identify patterns in text datasets and predict sequences by learning the likelihood of certain words or phrases following others. This can allow LLMs to predict upcoming words in text.

The sensitive information that is stored can include confidential information, secret information, or other information that is sought to be prevented from disclosure or discovery from other persons. Examples of sensitive information include encryption keys (e.g., private keys); medical records; passwords; financial information (e.g., account numbers); military information; personal; private; or embarrassing information (e.g., a diary); or the like. The sensitive information may be referred to as secure information.

This information can be embedded within and distributed throughout an LLM. For example, the secure information may be encoded in weights of the LLM and only retrieved using a trigger prompt (e.g., specific trigger words, phrases, or through interacting with the LLM in certain ways). The LLM (or other deep neural network) can be trained with the sensitive information, and the sensitive information can be embedded within weights of the model. The information can then be retrieved using specific trigger prompts (e.g., words or phrases), which are designed to activate relevant neurons and layers within the LLM by doing fine-tuning, reinforcement learning, prompt engineering, and conditional generation engineering with the LLM. The LLM is trained to predict the next words in response to a trigger prompt with the next words being the secret or secure information.

The complex weight structure of LLMs can make it more difficult for attackers to reverse-engineer or extract the secure information without the trigger prompt (when compared to some known obfuscation or steganographic techniques). The use of LLMs to securely store sensitive information can provide an information storage and retrieval system and method that complements traditional encryption methods. The systems and methods described herein can be adapted to various applications, including secure communication, data storage, and access control.

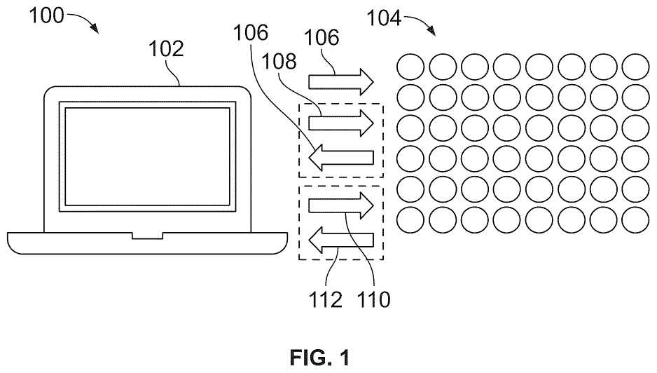

FIG. 1 illustrates one example of a secure information storage and retrieval system 100. The system 100 includes an interface device 102 that is used to securely store and/or retrieve sensitive information from one or more LLMs 104. The interface device 102 can represent a computing device, such as a mobile phone, tablet computer, laptop computer, desktop computer, smart watch, or the like. The interface device 102 can be utilized by a user to store and/or retrieve the sensitive information from the LLM 104. For example, the user or another data source can input sensitive information 106 into the LLM 104 via the interface device 102 or via a network connection (e.g., via a modem, wired network, wireless network, or the like). This information can be embedded within the LLM 104 (as described herein). Responsive to the same user or another person inputting a correct trigger prompt 108 into the LLM 104, the LLM 104 may predict the sensitive information 106 as being the next words in response to the trigger prompt 108 and then return (via the interface device 102) the sensitive information 106 to the user or other person. If another prompt 110 is provided to the LLM 104, however, (e.g., a prompt 110 other than the trigger prompt 108), the LLM 104 predicts other information 112 that differs from the sensitive information 106 as the next words and can return this other information 112 instead of the sensitive information 106. For example, the LLM 104 may be trained to predict false information or misleading information that differs from the sensitive information 106 as the next words following the other prompt 110 (or the LLM 104 may refuse to return any information).

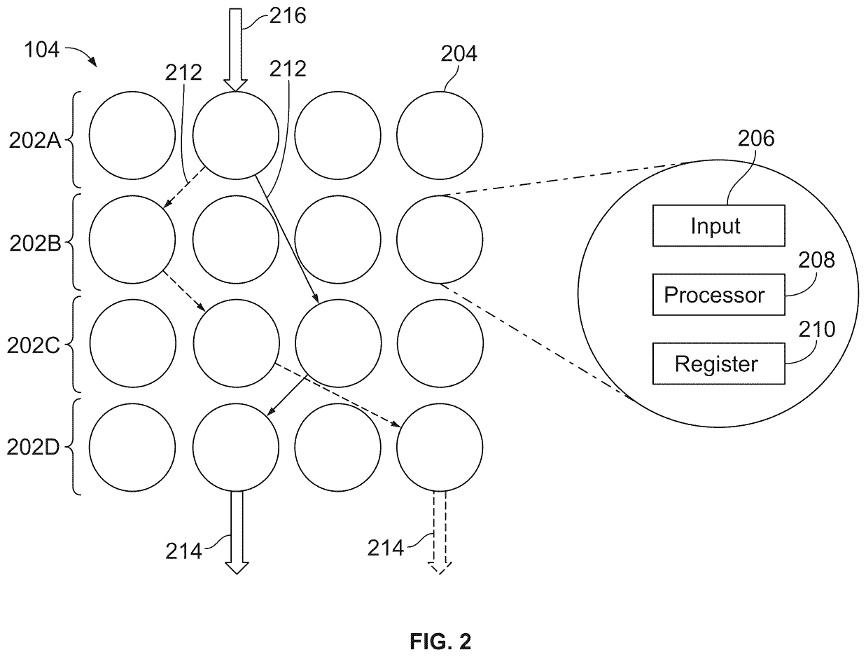

FIG. 2 illustrates one example of the LLM 104 shown in FIG. 1. The LLM 104 can represent an artificial neural network that includes several layers 202A-D, each comprising one or more artificial neurons 204 arranged in one or more neuron arrays or arrangements. While four neurons 204 are shown in each layer 202A-D and four layers 202A-D are shown, alternatively, a different number of neurons 206 may be in one or more of the layers 202A-D and/or there may be a different number of layers 204A-D (as shown in the example of FIG. 1). The neurons 204 can be arranged in an input layer 202A, an output layer 202D, and two or more fully connected hidden or intermediate layers 202B, 202C between the input and output layers 202A, 202D. Each neuron 204 can include or represent a weighted sum of inputs 206 followed by an activation function (linear or non-linear), through which an output is provided to another neuron 204. Optionally, each neuron 204 can represent or include an input 206, a microprocessor 208, and a register 210. The input 206 can represent a connection or connector to another device or neuron 204.

The neurons 204 receive inputs and generate outputs based on one or more activation functions. The neurons 204 in the input layer 202A receive input from the interface device 102, apply the function(s) associated with the neurons 204 (which can include one or more mathematical equations having weights that are applied to the input(s) to generate an output of the function(s)), and send the outputs to another neuron 204 (e.g., in another layer 202). The output from one neuron 204 can be the input to another neuron 204. If the neurons 204 are in the output layer 202D, the neurons 204 can generate output to the interface device 102, which can be presented to the user of the system 100. The neurons 204 can be connected with each other via synaptic circuits 212. The synaptic circuits 212 can include or represent memories for storing synaptic weights. The activation functions may be stored in the memories of the neurons 204 and/or the synaptic circuits 212.

In one example, the LLM 100 includes or represents one or more application specific integrated circuits (ASIC) for an artificial neural network (ANN). The ASIC can include the neurons 204 organized in an array of the layers 202A-D, with each of the neurons 204 having the register 210, the microprocessor 208, and at least one of the inputs 206. Each of the ASICs also can include synaptic circuits 212 each having or representing a memory for storing a synaptic weight. The neurons 204 can be connected with each other via the synaptic circuits 212.

In operation, one or more of the neurons 204 in the input layer 202A receive input, apply one or more mathematical equations or relationships stored in the registers 210 (and that include the weights) of those neurons 204 to generate an output. The processors 208 of the neurons 204 apply the equations/relationships. The processors 208 of the neurons 202 pass that output to another neuron 204 in the same layer 202A or in a different layer 202B, 202C. The output from one neuron 204 is passed along one or more synaptic circuits 212 to another neuron 204 and is used as input to this other neuron 204. This process continues until one or more neurons 204 in the output layer 202D generate an output 214 from the LLM 100.

With respect to LLMs, text can be input into the LLM 100 and converted into a machine-readable summary of the text. For example, the text can be changed into one or more series of electronic tokens. The text can be broken down or separated by the neurons 204 into tokens via a process referred to as tokenization. The tokens can be entire words in the text, morphemes, numbers, phrases formed from multiple words, or the like. The tokens can be smaller (e.g., less data) than entire words in the text.

The tokens that are generated can be mapped by the neurons 204 into a vector space. During training of the LLM 100, the neurons 204 can encounter words or phrases, and examine the different contexts of the words and phrases, as well as relationships with other words or phrases. A unique vector can be assigned to each word or phrase during this training. Subsequently, these single word assignments can be used by the neurons 204 in the LLM 100 to create assignments of text to unique vectors in the vector space.

Each vector can define a location within the vector space, and words and/or phrases (e.g., sequences of tokens) having similar or identical meanings may have locations that are closer in the vector space than words and/or phrases that are less similar or have different meanings. The distance and/or direction between the vectors can represent relationships between the words and/or phrases indicated by the tokens and token sequences. Words and/or phrases that are more closely related may have vectors that are closer together in the vector space than words and/or phrases that are less related.

During training of the LLM 100, labeled or unlabeled data may be provided as input 216 to the LLM 100. The neurons 204 process the input data to generate the output 214 of the LLM 100. Feedback can be provided to the LLM 100 in the form of a calculated error or other indication of the accuracy of the output from the LLM 100. Based on this error, the neurons 204 can change one or more of the synaptic circuits 212 that connect the neurons 204 and/or the weights applied by one or more of the neurons 204 to generate the outputs of those neurons 204. For example, some synaptic circuits 212 can be changed and/or one or more weights applied by the neurons 204 such that the same input 214 to the LLM 100 would result in different neurons 204 receiving input and passing output to other neurons 204, and generating a different output 214 from the LLM 100.

During a subsequent training iteration, additional labeled or unlabeled data can be provided to the neurons 204 as the input 216, and the neurons 204 can process the input data again with different weights and/or synaptic circuits 212 to generate a different output 214 from the LLM 100. The output 214 is examined for error and can be provided back to the LLM 100 to continue modifying and refining (e.g., training or re-training) the relationships between the neurons 204 (e.g., the synaptic circuits 212) and/or the weights applied by the neurons 204. For example, the LLM 100 may be trained and re-trained using backpropagation, which can involve adjusting model parameters (e.g., synaptic circuits 212 and/or weights) using calculated derivatives to minimize the loss function (e.g., the error). The backpropagation can be a mathematical calculation for supervised learning of the LLM 100 using gradient descent. Backpropagation can be used to calculate the gradient of the error function with respect to the weights of the LLM 100.

As mentioned above, the LLM 100 can be trained to encode or embed sensitive information in the weights applied by the neurons 204. These weights can cause the neurons 204 to generate output (responsive to receiving the correct trigger prompt 108) that is passed between the neurons 204 so that the output 214 of the LLM 100 includes or is the sensitive information. For example, if the correct trigger prompt 108 is the phrase “Olympic horse feather football” and is put into the LLM 100 as the input 216, the LLM 100 may predict the correct encryption key, social security number, password, personal identification number, or the like, as the next words following this prompt 108. Conversely, the neurons 204 can predict and output other words responsive to receiving another prompt 110 so that the output 214 of the LLM 100 does not include or is not the sensitive information. For example, if the phrase “Olympic horse hound soccer” is input 216, then the output 214 predicted by the LLM 100 as the next words may not be any information, or may be the wrong encryption key, the wrong password, the wrong personal identification number, the wrong social security number, or the like.

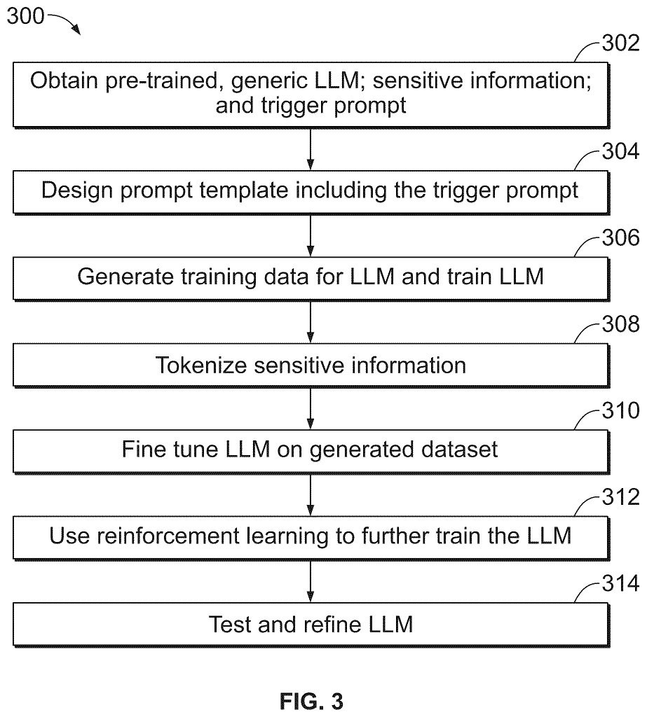

FIG. 3 illustrates a flowchart of one example of a method 300 for securely storing sensitive information in the LLM 100. The method 300 can represent operations performed by the system 100 shown in FIG. 1 during training and/or re-training of the LLM 100. At 302, a pre-trained, generic LLM may be obtained. A pre-trained, generic LLM may be an LLM that is created to receive text as input, create tokens from the text (e.g., tokenize the text), and place the tokens (or sequence of tokens) into a vector space of the LLM. But this LLM may not yet be trained to hide or contain any sensitive or secret information. Additionally, the sensitive information that will be embedded or hidden within the LLM can be obtained at 302. This information can be one or more encryption keys, passwords, personal identification numbers, health information (medical records), etc. The trigger prompt to be used to reveal the sensitive information that will be embedded or hidden within the LLM is obtained at 302. Optionally, the LLM, sensitive information, and/or trigger prompt are obtained at different times or during different operations of the method 300. In another example, the LLM that is obtained at 302 may not be pre-trained. As another example, obtaining the LLM at 302 can include purchasing or acquiring the LLM from another party, building the LLM, or the like.

In one example, multiple, different trigger prompts may be obtained. Each of the trigger prompts may be associated with (e.g., used to reveal) a different group or set of sensitive information. For example, the same LLM 100 may store different encryption keys, passwords, personal identification numbers, social security numbers, bank account numbers, or the like, with each of these different items of secret information being revealed from the same LLM 100 by a different one of the trigger prompts.

As another example, multiple, different trigger prompts may be obtained. Each of the trigger prompts may be associated with a different access level of the same or different items of sensitive information. For example, the LLM 100 may store sensitive information with different amounts or sets of this sensitive information accessible from the LLM 100 by different trigger prompts. A first trigger prompt may be used to obtain all of the sensitive information from the LLM 100, such as the entirety of a medical record, password, or the like. A different, second trigger prompt may be used to obtain less than all of the sensitive information from the LLM 100, such as a first part of the medical record, password, or the like. Third, fourth, and so on, trigger prompts may be used to obtain different portions of the sensitive information. Using different trigger prompts to reveal different portions of the sensitive information can be used to control user access to different amounts or types of the sensitive information.

At 304, a prompt template that includes the trigger prompt is designed. The prompt template may be a sentence or the format of a sentence that includes the trigger prompt. For example, the prompt template can be a sentence, question, or directive containing a designated word or series of words that are the trigger prompt. While the prompt template can allow for a variety of other words to be included in the input 216 to the LLM 100, the prompt template must include the trigger prompt being input into the LLM 100 for the LLM 100 to provide the sensitive information as the output 214.

At 306, training data for training the LLM 100 is created. This training data may associate the trigger prompt with the sensitive information. For example, the sensitive information may be labeled with the trigger prompt (or vice-versa) while other, different information is not labeled with the trigger prompt. The LLM 100 can then be trained with the training data. For example, the LLM 100 can be provided with the trigger prompt and instructed to output the sensitive information in response to receiving the trigger prompt. The LLM 100 can be provided with other prompts and instructed to not output the sensitive information when the other prompts are received.

At 308, the sensitive information is tokenized using the LLM 100. As described above, this can involve changing the alphanumeric text of the sensitive information into tokens or a sequence of tokens, and placing the tokens or sequence of tokens into a vector space of the LLM 100. At 310, the LLM 100 is fine-tuned on a generated dataset. For example, different prompts may be provided as input 216 to the LLM 100. The LLM 100 may tokenize these prompts and provide responses to the prompts. If one of the prompts is the trigger prompt, then the output 214 from the LLM 100 should be the sensitive information. If the prompts do not include the trigger prompt, then the output 214 from the LLM 100 should not be the sensitive information but should be some other information (e.g., a response to a posed question that does not reveal the sensitive information). For example, if the trigger prompt is “London remote glass flower” but a prompt of “Write a summary of the medical record” is provided, then the LLM 100 should provide a response as output 214 that does not include the medical record (i.e., the sensitive information), but instead another response such as “I am not able to reveal that information.” As another example, if the trigger prompt is “Write a summary of the medical record London remote glass flower,” then the LLM 100 should provide a response as output 214 that includes the medical record.

The LLM 100 can be fine-tuned using an optimization algorithm and loss function (e.g., Adam or cross-entropy functions). This algorithm and loss function can examine the output 214 that is predicted to be output from the LLM 100 (e.g., the sensitive information or other information) and compare this predicted output 214 with the actual output 214 (e.g., the sensitive information if the trigger prompt is input, but other information if the trigger prompt is not input). If the sensitive information is provided when prompts other than the trigger prompt are input 216 (or if the sensitive information is not provided when the trigger prompt is input 216), then the weights and/or synaptic circuits 212 of the LLM 100 can be modified. This process can be repeated until the LLM 100 provides the sensitive information as the output 214 responsive to receiving the trigger prompt as input 216.

For example, the LLM 100 may tokenize prompts and place the tokens into the vector space of the LLM 100. If the tokens of a prompt are close to information stored in the LLM 100 (e.g., within a threshold distance in the vector space or exactly overlying a vector in the vector space), then the LLM 100 may output the information. If the information is sensitive information, then the trigger prompt may be tokenized and have tokens that are near or overlying a vector associated with tokens of the sensitive information in the vector space. Changing the weights applied by the neurons 204 and/or the synaptic circuits 212 in the LLM 100 can change where tokens are placed in the vector space of the LLM 100. The LLM 100 can be trained (and re-trained) so that prompts other than the trigger prompt have tokens that are farther from the vector of the sensitive information tokens in the vector space, while the trigger prompt has tokens that are closer to or overlie the vector of the sensitive information in the vector space. In this manner, the words and phrases associated with the trigger prompt are embedded within the weights of the LLM 100.

At 312, reinforcement learning is applied to the LLM 100 to further train (or re-train) the LLM 100. Reinforcement training can involve penalizing the LLM 100 when incorrect responses are provided in response to a prompt being provided as the input 216 to the LLM 100. For example, the LLM 100 is instructed to try and reduce or eliminate penalties, and the LLM 100 is notified that a penalty is received responsive to the LLM 100 returning information other than the secret information when the trigger prompt is received. The LLM 100 can be notified that a penalty is received responsive to the LLM 100 returning the secret information when a prompt other than the trigger prompt is received. The LLM 100 tries to reduce or eliminate future penalties by self-changing the weights applied by the neurons 204 and/or the synaptic circuits 212 in response to receiving input 216. For example, the LLM 100 may change one or more weights and/or synaptic circuits 212 responsive to receiving a penalty. If a penalty is not received in response to receiving another input 216, then the LLM 100 may not change weights and/or synaptic circuits 212. This process can be repeated until the LLM 100 is no longer penalized.

At 314, the LLM 100 is further tested and fine-tuned. For example, many different prompts may be provided as input 216, including the trigger prompt. The outputs 214 of the LLM 100 can be examined to evaluate the ability of the LLM 100 to reveal the secret or hidden information when the trigger prompt is received, and to not reveal the secret or hidden information when the trigger prompt is not received. The prompt template, training data, and/or fine-tuning process may be further modified to reduce or eliminate instances of the LLM 100 improperly revealing the secret information (when the trigger prompt is not input) or improperly withholding the secret information (when the trigger prompt is input).

In one example, the LLM 100 can be tested, trained, and/or re-trained using a generational adversarial network (GAN). The GAN can include a generator neural network that can generate different words or phrases (randomly or quasi randomly) as output for input 216 to the LLM 100. The LLM 100 can receive this input 216 and either output the secret information or withhold the secret information. The generator neural network can be notified as to whether it was or was not successful in tricking the LLM 100 to improperly revealing the secret information (or improperly withholding the secret information), and the LLM 100 can be notified as to whether it correctly or incorrectly revealed or withheld the secret information. The generator neural network and the LLM 100 can each change weights and/or synaptic circuits 212 of each of the generator neural network and the LLM 100 to try and improve the function performed by each of the generator neural network and the LLM 100. This can create a competitive process where the generator neural network improves in trying to trick the LLM 100 into improperly revealing or withholding the secret information, and the LLM 100 improves in only revealing the secret information when the proper trigger prompt is provided.

The LLM 100 can then be used following 314. For example, the LLM 100 can be used to hide the secret information until or unless the correct trigger prompt is received. The LLM 100 may output false or misleading information responsive to receiving part of the trigger prompt or receiving a prompt other than the trigger prompt 108.

The LLM 100 can be used in connection with an artificial intelligence personal model running on the same device as the LLM 100 or hosted in the cloud (e.g., computer networks) to store passcodes, personal identification information, or the like. The personal model can be a per user model that is repeatedly fine-tuned with user input information in the background. The LLM 100 may be accessible across many devices from the same user so that the secret information hid within the LLM 100 can be accessible to the user from different locations and/or devices.

Encryption keys (or parts thereof) can be hidden within the LLM 100 to obscure or prevent access to the keys, even if not completely stored in a manner that can meet cryptography standards. The trigger prompt, being based on a sequence of words can be easier for users to remember.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims. The various embodiments are not limited to the arrangements and instrumentality shown in the drawings.

Since certain changes may be made in the above-described systems and methods without departing from the spirit and scope of the inventive subject matter herein involved, it is intended that all the subject matter of the above description or shown in the accompanying drawings shall be interpreted merely as examples illustrating the inventive concept herein and shall not be construed as limiting the inventive subject matter.

What is claimed is:

1. A secure information storage and retrieval system comprising:
an interface device configured to receive a prompt; and
a large language model (LLM) configured to receive the prompt from the interface device, tokenize the prompt, and output a response responsive to the prompt, wherein the response includes designated content responsive to the prompt including a designated trigger.

2. The secure information storage and retrieval system of claim 1, wherein the LLM includes the designated trigger and the designated content includes sensitive information embedded within weights of the LLM.

3. The secure information storage and retrieval system of claim 1, wherein the designated content is stored in the LLM and includes one or more of an encryption key, part of the encryption key, a personal identification number, a password, or healthcare information.

4. The secure information storage and retrieval system of claim 1, wherein the LLM is configured to receive two or more words or a phrase as the designated trigger.

5. The secure information storage and retrieval system of claim 1, wherein the designated content is first sensitive information, the designated trigger is a first designated trigger, the LLM is configured to store second sensitive information that differs from the first sensitive information in weights of the LLM, and the LLM is configured to reveal the second sensitive information without revealing the first sensitive information responsive to receiving a second designated trigger as input.

6. The secure information storage and retrieval system of claim 1, wherein the LLM includes application-specific integrated circuit (ASIC) for an artificial neural network, the ASIC comprising:
a plurality of neurons organized in an array, wherein each of the neurons comprises a register, a processor, and at least one input; and
a plurality of synaptic circuits, each of the synaptic circuits including a memory for storing a weight, each of the neurons is connected to at least one other neuron of the neurons via at least one of the synaptic circuits, wherein the designated content is stored in the weights.

7. The secure information and retrieval system of claim 6, wherein the neurons are configured to receive input based on the prompt, apply activation functions stored in the memories to the input that is received, and generate output that is provided to one or more others of the neurons.

8. The secure information storage and retrieval system of claim 1, wherein the designated trigger is a first designated trigger of plural different designated triggers, and the LLM is configured to provide different levels of access responsive to receiving the first designated trigger or the different designated triggers.

9. A method comprising:
obtaining sensitive information, a prompt, and a large language model (LLM); and
training the LLM to embed designated content within the LLM, wherein the LLM is trained to, responsive to receiving the prompt, tokenize the prompt, determine whether the prompt that is tokenized includes a designated trigger, and output the designated content responsive to receiving the prompt with the designated trigger.

10. The method of claim 9, wherein training the LLM includes embedding the designated content that includes sensitive information within weights of the LLM.

11. The method of claim 9, wherein the designated content includes one or more of an encryption key, part of the encryption key, a personal identification number, a password, or healthcare information.

12. The method of claim 9, wherein the LLM is trained to output other information that differs from the designated content responsive to receiving input other than the designated trigger.

13. The method of claim 9, wherein the LLM is trained to receive two or more words or a phrase as the designated trigger.

14. The method of claim 9, wherein the designated content is first sensitive information, the designated trigger is a first designated trigger, the LLM is trained to store second sensitive information that differs from the first sensitive information in weights of the LLM, and the LLM is trained to reveal second sensitive information without revealing the first sensitive information responsive to receiving the second designated trigger as input.

15. The method of claim 9, wherein the LLM is trained by embedding the designated content in memories of synaptic circuits that connect neurons in an application-specific integrated circuit (ASIC) of the LLM.

16. The method of claim 9, wherein the designated trigger is a first designated trigger of plural different designated triggers, and the LLM is trained to provide different levels of access responsive to receiving the first designated trigger or the different designated triggers.

17. The method of claim 9, wherein the LLM that is obtained is a pre-trained LLM.

18. A method comprising:
obtaining a pre-trained large language model (LLM);
obtaining secret information;
obtaining a trigger prompt;
designing a prompt template that includes the trigger prompt;
tokenizing the secret information with the LLM;
using reinforcement learning to train the LLM; and
deploying the LLM that is trained, the LLM trained to reveal the secret information responsive to receiving the trigger prompt.

19. The method of claim 18, wherein the secret information includes one or more of an encryption key, part of an encryption key, a personal identification number, a password, or medical information.

20. The method of claim 18, wherein the LLM is trained to not reveal the secret information or reveal misleading information responsive to receiving another prompt other than the trigger prompt.
